(19) United States
(12) Patent Application Publication
(10) Pub. No.: US 2012/0242686 A1
(43) Pub. Date: Sep. 27, 2012

(54) Use of mobile phone Wallpaper to display vital information

(76) Inventor: Samuel Okechukwu Umealu, Melbourne (AU)

(21) Appl. No.: 13/071,508

(22) Filed: Mar. 25, 2011

(51) Int. Cl. G09G 5/00

(52) U.S. Cl. 345/629

(57) ABSTRACT

Superimposition of information on image files is not by itself novel. The originality of this invention lies on superimposing information on an image file by using any of the methods described in Section 8 (Detailed Description of the Invention) and then using the resulting image in the manner described in Section 6 (Brief Summary of the Invention) to provide a solution to the problems described in Section 5 (Background of Invention) and to add value to the use of mobile phone as listed in Section 6 (Brief Summary of the Invention).

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

When a mobile phone is lost and found, the finder usually experiences difficulty in identifying the owner of the handset and hence how to return it to the owner. It is almost impossible to return the handset to its owner without vital information about its owner, as well as, how and where to return it.

Mobile phones are increasingly being used to store valuable information and data such as contact details, diary, notes, memos, photographs, music and so on. It is therefore becoming increasingly necessary for an owner of a mobile phone handset to give reward to others who may find and return the handset, in the event that it is lost. The knowledge of the monetary value of the Reward would serve as an incentive for the return of a lost and found mobile phone. However, it is not usually obvious how and where such information on “Reward” may be clearly displayed for the benefit of others who may find a lost mobile phone.

Provision of the terms and conditions by an organisation and acceptance of those terms and conditions by users normally constitutes legal and policy requirements before misuse of a corporate asset can be alleged. Organisations currently seem to have the problem of how and where to display the terms and conditions for the use of this asset. Consequently, they find it difficult and sometimes impossible to legally protect one of their most important categories of assets (mobile phone handsets) from misuse.

### BRIEF SUMMARY OF THE INVENTION

This invention provides viable solution to problems described in the “Background of the Invention” section. It superimposes vital information on an image file which is then used as “wallpaper” on a typical mobile phone handset, as illustrated by the diagrams in the “Drawing” section. The invention delivers the following values:
1. Provide vital information regarding where and how to return a “lost and found” mobile phone handset, for the benefit of others who may come across the handset. This information may include one or more of the following:
   i. Name of an individual or corporate entity
   ii. An address of where to return the handset
   iii. Phone number to call in the event that the handset is lost and found
   iv. Reward
   v. Any other piece(s) that may be considered vital for the purpose of returning a “lost and found” mobile phone handset.
2. Provides a platform or medium for an individual or organisation to alert others to the fact that keeping and/or any un-authorised use of the handset is an offence for which the offender may be legally prosecuted.
3. Provides a platform or medium for an individual or organisation to alert others to the fact that illegal use of the handset constitutes legal offence or a breach of corporate policy.
4. Provides a platform or medium for an individual or organisation to alert others as to what may constitute an illegal use of the handset.
5. Provides a platform or medium for an individual or organisation to alert potential users as to term and conditions for the use of mobile phone handset.
6. Provides information on rewards should the handset be returned which may act as an incentive for a “lost and found” handset to be returned to the owner.

### BRIEF DESCRIPTION OF THE SEVERAL VIEWS OF THE DRAWINGS

This invention is illustrated more clearly in a photograph rather than a hand drawing. A box is then drawn on the photograph to further improve elaboration. It contains one diagram depicted as FIG. 1, in the “Drawing” section.

FIG. 1 illustrates the result of superimposing an image file, which is to be used as a wallpaper of a mobile phone handset, with useful information by any of the methods listed in the “Detailed Description of the Invention” section. The box labeled “A”, contains a sample of useful information that may be superimposed on a typical image file. An image file of one's choice can be used for this purpose.

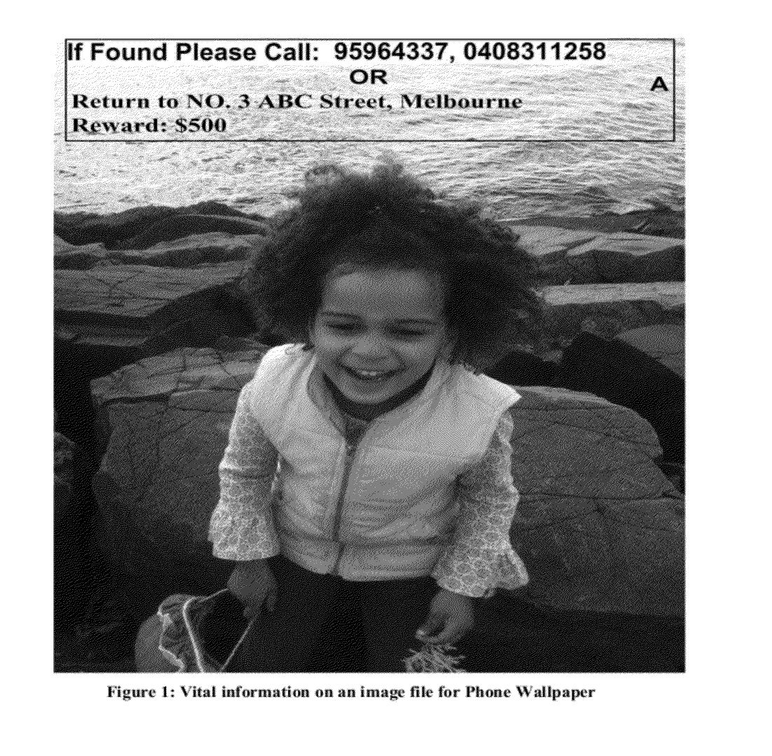

### DETAILED DESCRIPTION OF THE INVENTION

This invention is about using the image file of one's choice to display useful information, as listed in “Brief Summary of the Invention” section, on any part of the wallpaper of a mobile phone handset. This is for the benefit of others who may come across the phone when it is lost and wish to return it to the owner. It is also for the benefit of someone or organisations who would want to alert others of the terms and conditions of using a particular mobile phone handset.

This is achieved by superimposing the required information on an image file which is then used as the wallpaper of a mobile phone handset. Superimposition of the information on an image file for this purpose may include but not limited to the following methods:
1. Importing the original image file into Microsoft® Paint and/or any other similar software and then putting the required information on the image.
2. Utilizing a software or process that prompts user to enter the required information on the original image file which is intended to be use as wallpaper. This information may be displayed on the wallpaper as provided. Alternatively, information displayed on the wallpaper may be a derivative from or a translation of some other piece(s) of information.
3. Utilizing a software or process that prompts user to enter the required information on the original image file which is already in use as wallpaper. This information may be displayed on the wallpaper as provided. Alternatively, information displayed on the wallpaper may be a derivative from or a translation of some other piece(s) of information.
4. Using a software or process which utilises information provided on an online screen. This information may be displayed on the wallpaper as originally provided. Alternatively, information displayed on the wallpaper may be a derivative from or a translation of some other piece(s) of information.
5. Using a software or process to read the contents of a data file or database table to retrieve information which is then displayed on the wallpaper. This data may be displayed on the wallpaper as retrieved from a data file or database table. Alternatively, information displayed on the wallpaper may be a derivative from or a translation of the original data as contained in data file or database table.
6. Using a software or process which utilises voice input to form visual data which is then displayed on the wallpaper.

1. Superimposition of information on an image file by any or combination of methods listed in section A below and to then use the resulting file (image plus superimposed information) as the wallpaper of a mobile phone handset for any of the purposes listed in section B below.
Section A
I Import the original image file into Microsoft® Paint and any other similar software and then putting the required information on the image.
II. Utilize a software or process that prompts user to enter the required information on the original image file which is intended to be use as wallpaper. This information may be displayed on the wallpaper as provided. Alternatively, information displayed on the wallpaper may be a derivative from or a translation of some other piece(s) of information.
III. Utilize a software or process that prompts user to enter the required information on the original image file which is already in use as wallpaper. This information may be displayed on the wallpaper as provided. Alternatively, information displayed on the wallpaper may be a derivative from or a translation of some other piece(s) of information.
IV. Use a software or process which utilises information provided on an online screen. This information may be displayed on the wallpaper as originally provided. Alternatively, information displayed on the wallpaper may be a derivative from or a translation of some other piece(s) of information.
V. Use a software or process to read contents of a data file or database table to retrieve data which is then used to form the information to be displayed on the wallpaper. This data may be displayed on the wallpaper as retrieved from a data file or database table. Alternatively, information displayed on the wallpaper may be a derivative from or a translation of the original data as contained in data file or database table.
VI. Use a software or process which utilises voice input to form visual data which is then displayed on the wallpaper.
Section B
I. Provide information on where and how to return a “lost and found” mobile handset, including but not limited to one or more of the following:
1. Name of an individual or corporate entity
2. An address of where to return the handset
3. Phone number to call in the event that the handset is lost and found
4. Reward
5. Any other piece(s) that may be considered vital for the purpose of returning a “lost and found” mobile phone handset.
II. Provide a platform or medium for an individual or organisation to alert others to the fact that keeping and/or any un-authorised use of a “lost and found” mobile phone handset is an offence for which the offender may be legally prosecuted.
III. Provide a platform or medium for an individual or organisation to alert others to the fact that illegal use of a mobile phone handset constitutes legal offence or a breach of corporate policy.
IV. Provide a platform or medium for an individual or organisation to alert others as to what may constitute an illegal use of a mobile phone handset.
V. Provide a platform or medium for an individual or organisation to alert potential users as to term and conditions for the use of a mobile phone handset.
VI. Provide information on rewards should the handset be returned which may act as an incentive for a “lost and found” mobile phone handset to be returned to the owner.
VII. Provide a disincentive to keep a “lost and found” mobile phone handset by the finder.
